(19) United States
(12) Patent Application Publication
(10) Pub. No.: US 2006/0132694 A1
(43) Pub. Date: Jun. 22, 2006

(54) Low-cost integrated liquid crystal display monitor

(75) Inventor: Chen-Hsun Liao, Tu-Cheng (TW)

Correspondence Address: PCE INDUSTRY, INC.;ATT. CHENG-JU CHIANG JEFFREY T. KNAPP, 458 E. LAMBERT ROAD, FULLERTON, CA, 92835, US

(73) Assignee: HON HAI Precision Industry CO., LTD., Tu-Cheng City (TW)

(21) Appl. No.: 11/228,820

(22) Filed: Sep. 16, 2005

(30) Foreign Application Priority Data
Dec. 17, 2004 (CN) 200420103108.5

(51) Int. Cl. G02F 1/1345

(52) U.S. Cl. 349/149

(57) ABSTRACT

A liquid crystal display device (8) includes a TFT LCD panel (10), a power/inverter board (20) and an interface board (30). The LCD panel includes a liquid crystal display (12), a backlight module (14) and a driving circuit (16). The power/inverter board and the interface board are installed on one printed circuit board (40), and a certain distance is left therebetween. An inverter circuit of the power/inverter board is electrically connected with a CCFL (142) of the backlight module and is used to convert direct current (DC) into alternating current (AC) to light on the CCFL. The interface board is electrically connected with the driving circuit and is used to receive RGB (red, green and blue) signals, process and send said signals to the driving circuit. That the power/inverter board and the interface board are integrated on one printed circuit board reduces the cost of the liquid crystal display device and ensures stable work thereof.

### BACKGROUND

1. Field of the Invention

The invention relates generally to liquid crystal display device and, more particularly, to an integrated liquid crystal display device which has a low cost and which can be assembled easily.

2. Discussion of the Related Art

Liquid crystal display (LCD) devices, such as liquid crystal display monitors, have many excellent performance features, such as large-scale information display capability, low power consumption, easy to color, long life, no pollution and so on. Therefore, the liquid crystal display devices are used widely. Referring to FIG. 2 (Prior Art), a typical LCD device includes a thin film transistor (TFT) LCD panel 10, a power board, an inverter board and an interface board 30.

The TFT LCD panel 10 includes a TFT liquid crystal display 12, a backlight module 14 and a driving circuit 16. The backlight module 14 includes a cold-cathode fluorescent lamp (CCFL) and a backlight system. Currently, the power board and the inverter board are integrated as a power/inverter board 20. The power/inverter board 20 is installed on a first printed circuit board 22 and includes a power circuit and an inverter circuit. The inverter circuit of the power/inverter board 20 is electrically connected with the CCFL of the backlight module 14 and is used to convert direct current (DC) into alternating current (AC) to light on the CCFL. The interface board 30 is installed on a second printed circuit board 32 and is electrically connected with the driving circuit 16. The interface board 30 is used to receive RGB (red, green and blue) signals, process and send said signals to the driving circuit 16.

However, the liquid crystal display device shown in FIG. 2 has the following disadvantages. Firstly, two separate printed circuit boards 22, 32 must be adopted, and this results in more process in the production line thereby increasing manufacturing cost of the liquid crystal display device. Secondly, a harness must be added to connect the power/inverter board 20 with the interface board 30. The connection is prone to fail and thus the liquid crystal display device can't work stably.

What is needed, therefore, is a liquid crystal display device which has a low cost and which can work stably.

### SUMMARY

In one embodiment, a liquid crystal display device includes a TFT LCD panel, a power/inverter board and an interface board. The TFT LCD panel includes a liquid crystal display, a backlight module and a driving circuit. The backlight module includes a cold-cathode fluorescent lamp (CCFL) and a backlight system. The power/inverter board includes a power circuit and an inverter circuit. The power/inverter board and the interface are installed on one printed circuit board, and a certain distance is left therebetween. The inverter circuit of the power/inverter board is electrically connected with the CCFL of the backlight module and is used to convert direct current (DC) into alternating current (AC) to light on the CCFL. The interface board is electrically connected with the driving circuit. The interface board is used to receive RGB (red, green and blue) signals, process and send said signals to the driving circuit.

Compared with a conventional liquid crystal display device, the present liquid crystal display device has the following advantages. Firstly, the power/inverter board and the interface board are integrated on one printed circuit board, and this integration negates the need for yet a second printed circuit board. Furthermore, one printed circuit board has relatively little process in the production line. As such, the manufacturing cost of the liquid crystal display device is decreased, due to a reduction in the number of parts needed and in the amount of labor required for assembly. Secondly, there is no an added harness to connect the power/inverter board with the interface board. This avoids the connection failure thereby ensuring that the liquid crystal display device can work stably.

Other advantages and novel features of the present LCD device will become more apparent from the following detailed description of preferred embodiments when taken in conjunction with the accompanying drawings.

### BRIEF DESCRIPTION OF THE DRAWINGS

Many aspects of the present LCD device can be better understood with reference to the following drawings. The components in the drawings are not necessarily to scale, the emphasis instead being placed upon clearly illustrating the principles of the present LCD device. Moreover, in the drawings, like reference numerals designate corresponding parts throughout the several views.

FIG. 1 is a block diagram showing a structure of a liquid crystal display device in accordance with an embodiment of the present device; and

FIG. 2 is a block diagram showing a structure of a conventional liquid crystal display device.

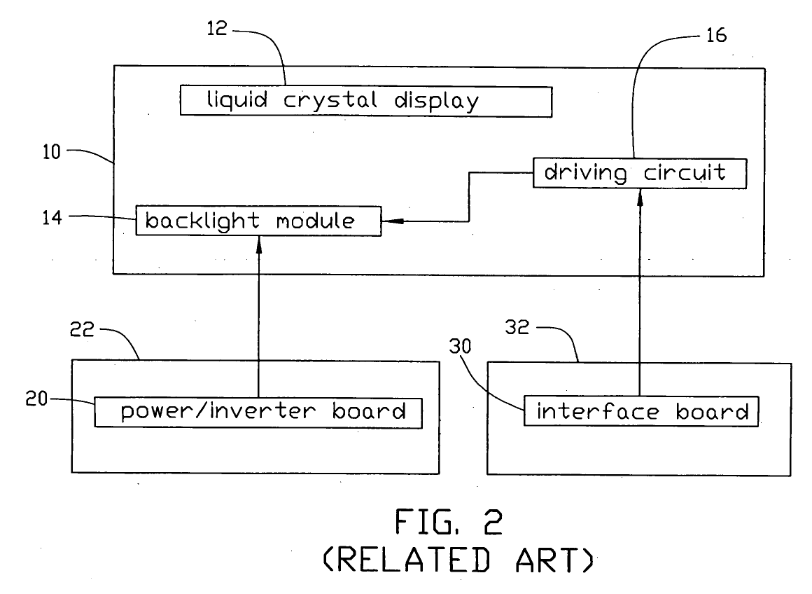

Corresponding reference characters indicate corresponding parts throughout the several views. The exemplifications set out herein illustrate at least one preferred embodiment of the present LCD device, in one form, and such exemplifications are not to be construed as limiting the scope of the present LCD device in any manner.

### DETAILED DESCRIPTION OF PREFERRED EMBODIMENTS

Reference will now be made to the drawings to describe embodiments of the present liquid crystal display device in detail.

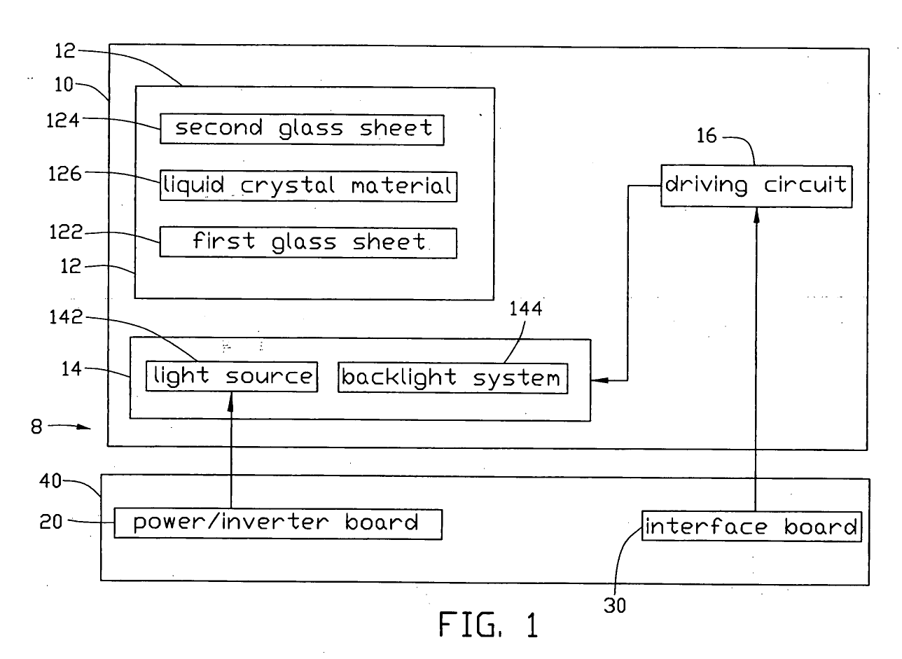

Referring to FIG. 1, a liquid crystal display device 8 in accordance with one embodiment of the present device is a liquid crystal display monitor and includes a TFT LCD panel 10, a power/inverter board 20 and an interface board 30. The TFT LCD panel 10 includes a liquid crystal display 12, a backlight module 14 and a driving circuit 16. The liquid crystal display 12 includes a first piece of glass sheet 122, a second piece of glass sheet 124 and a liquid crystal material 126 sandwiched therebetween. The liquid crystal material 126 includes a plurality of liquid crystal molecules. The backlight module 14 includes a light source 142 and a backlight system 144. In the embodiment, the light source 142 is a cold-cathode fluorescent lamp (CCFL).

The power/inverter board 20 includes a power circuit and an inverter circuit. The power/inverter board 20 and the interface 30 are installed on one printed circuit board 40. A distance is left between the power/inverter board 20 and the interface board 30. This distance inhibits and/or prevents Electro Magnetic Interference (EMI) produced by the power/inverter board 20 from affecting the interface board 30. In the embodiment, the power/inverter board 20 and the interface board 30 are advantageously positioned on opposite ends of the printed circuit board 40. The inverter circuit of the power/inverter board 20 is electrically connected with the CCFL 142 of the backlight module 14 and is used to convert direct current (DC) into alternating current (AC) to light on the CCFL 142. The interface board 30 is electrically connected with the driving circuit 16. The interface board is used to receive RGB (red, green and blue) signals, process and send said signals to the driving circuit 16.

In use, the inverter circuit of the power/inverter board 20 converts direct current into alternating current and supplies the alternating current to the light source 142. The cold-cathode fluorescent lamp 142 receives the alternating current and luminesces. The backlight system 144 converts the line light source by the cold-cathode fluorescent lamp 142 into an area light source, such an area light source, thereby having a high uniformity and brightness. The interface board 30 receives video signals from a signal-processing device or PC, processes the digital signals, and sends the digital signals to the driving circuit 16. The driving circuit 16 converts the digital signals into corresponding analog signals and supplies the liquid crystal display 12 with a driving voltage. The liquid crystal molecules of the liquid crystal material 126 twist/rearrange corresponding to the liquid crystal driving voltage. The area light source 142 reaches the first glass sheet 122, and the light beams thereof are refracted by the liquid crystal molecules and emitted from the second glass sheet 124. Therefore, an image in accordance with the video signals is displayed on the second glass sheet 124.

Compared with a conventional liquid crystal display device, the present liquid crystal display device 8 has the following advantages. Firstly, the power/inverter board 20 and the interface board 30 are integrated on one printed circuit board 40, and this integration negates the need for yet a second printed circuit board. Furthermore, one printed circuit board 40 has relatively little process in the production line. As such, the manufacturing cost of the liquid crystal display device 8 is decreased, due to a reduction in the number of parts needed and in the amount of labor required for assembly. Secondly, there is no added harness to connect the power/inverter board 20 with the interface board 30. This configuration avoids the connection failure, thereby ensuring that the liquid crystal display device can work stably.

Finally, it is to be understood that the above-described embodiments are intended to illustrate rather than limit the invention. Variations may be made to the embodiments without departing from the spirit of the invention as claimed. The above-described embodiments illustrate the scope of the invention but do not restrict the scope of the invention.

We claim:

1. A liquid crystal display device comprising:
a liquid crystal display panel; and
a power/inverter board and an interface board both installed on one printed circuit board and both electrically connected with the liquid crystal display panel.

2. The liquid crystal display device as claimed in claim 1, wherein a certain separation distance is left between the power/inverter board and the interface board, the separation distance being chosen so that Electro Magnetic Interference (EMI) produced by the power/inverter board is at least inhibited from affecting the interface board.

3. The liquid crystal display device as claimed in claim 1, wherein the power/inverter board comprises a power circuit and an inverter circuit.

4. The liquid crystal display device as claimed in claim 3, wherein the liquid crystal display panel comprises a liquid crystal display, a backlight module and a driving circuit.

5. The liquid crystal display device as claimed in claim 4, wherein the backlight module comprises a light source and a backlight system.

6. The liquid crystal display device as claimed in claim 5, wherein the inverter circuit is electrically connected with the light source.

7. The liquid crystal display device as claimed in claim 5, wherein the light source is a cold cathode fluorescent lamp.

8. The liquid crystal display device as claimed in claim 4, wherein the interface board is electrically connected with the driving circuit.

9. The liquid crystal display device as claimed in claim 4, wherein the liquid crystal display comprises two glass sheets and a liquid crystal material, the liquid crystal material being sandwiched between the two glass sheets.
